(19) United States
(12) Patent Application Publication
(10) Pub. No.: US 2014/0106080 A1
(43) Pub. Date: Apr. 17, 2014

(54) ULTRAVIOLET CURABLE COATING

(71) Applicant: Armstrong World Industries, Inc., Lancaster, PA (US)

(72) Inventors: Dong TIAN, Lancaster, PA (US); Larry W. LEININGER, AKRON, PA (US)

(73) Assignee: Armstrong World Industries, Inc., Lancaster, PA (US)

(21) Appl. No.: 14/140,206

(22) Filed: Dec. 24, 2013

Related U.S. Application Data
(63) Continuation of application No. 12/838,805, filed on Jul. 19, 2010, now abandoned.

(51) Int. Cl. C09D 133/08

(52) U.S. Cl. CPC C09D 133/08
USPC 427/508; 522/153; 522/83; 522/79; 522/71; 522/112; 522/151

(57) ABSTRACT

Ultraviolet curable compositions are disclosed that can be applied to achieve a uniform gloss after curing even under conditions of varying ultraviolet intensity during curing, that do not require continuous agitation to keep flattening agents and other additives suspended prior to application of the composition, and/or which do riot exhibit a significant increase in viscosity over time in a roll coater application.

### CROSS-REFERENCE TO RELATED PATENT APPLICATIONS

This application is a continuation of U.S. patent application Ser. No. 12/838,805, filed Jul. 19, 2010, the contents of which are hereby incorporated herein in their entirety.

### FIELD

The present invention relates to radiation curable compositions for use in coating substrates, and more particularly to Ultraviolet curable coatings for flooring and other applications.

### BACKGROUND

Radiation curable coatings, such as ultraviolet curable coatings, are applied to various types of substrates to enhance their durability and finish. These radiation curable coatings are typically mixtures of resins, oligomers, and monomers that are radiation cured after being applied to the substrate. The radiation curing polymerizes and/or cross-links the resins, monomers and oligomers to produce a coating having desirable properties, including abrasion and chemical resistance. Radiation curable coatings of this type are often referred to as topcoats or near layers and are used for example, in a wide variety of flooring applications, such as on linoleum, hardwood, resilient sheet, and tile, flooring.

Current ultraviolet curable coatings often include a flattening agent by which the gloss associated with the coating when cured on the substrate can be controlled to achieve a desired level. One way in which the gloss level can be controlled is by varying the intensity of the ultraviolet radiation as disclosed, for example, in U.S. Pat. Nos. 6,333,076 and 6,572,932. However, in certain manufacturing environments, unintentional variations in ultraviolet radiation intensity can lead to the opposite effect, making a uniform gloss difficult to achieve across the surface of the cured substrate. When curing wide sections of substrate, it may be necessary to use multiple banks of ultraviolet lamps to cover a wide web, but which also results in variations of ultraviolet intensity, especially in the area adjacent two ultraviolet lamps. This in turn can lead to banding, in which certain areas of the substrate have an unacceptably higher or lower gloss level at the cured surface than that of the rest of the substrate.

Another problem associated with current ultraviolet curable coatings is that the flattening agents must be thoroughly distributed in the ultraviolet coating prior to the application thereof. Thus, current low viscosity coatings for use in roller coating applications must be continuously agitated to prevent settling or other separation of the particles. Additionally, problems with separation occur in ultraviolet curable coatings where lighter particles intended to act as a texturizer are introduced into the ultraviolet curable coating, because these lighter particles have a tendency to float to a top of the ultraviolet curable coating.

A still further problem associated with current ultraviolet curable coatings is that the ultraviolet curable coatings exhibit an increase in viscosity over time during coating applications. This increase in viscosity results in a more difficult application of the ultraviolet curable coating to the substrate, particularly when the ultraviolet curable coating is being applied by roll coating, which requires a fluid that is shear thinning.

### SUMMARY

Exemplary embodiments are directed to ultraviolet curable compositions that can be applied, for example, to a substrate to achieve a substantially uniform gloss after curing even under conditions of varying ultraviolet intensity, that do not require continuous agitation to keep flattening agents and other additives suspended prior to application, and/or which do not exhibit a significant increase in viscosity over time during coating applications.

According to an embodiment, a low-gloss ultraviolet curable composition comprises an ultra violet curable acrylate resin, a photoinitiator, and at least three different solid additives dispersed within the ultraviolet curable composition. At least two of the solid, additives are flattening agents in which the first flattening agent has a property that is different with respect to that of the second flattening agent, the property selected from the group consisting of composition, particle size, particle size distribution, surface treatment, surface area and porosity. In some embodiments, the third solid additive is a texturizer.

According to another embodiment, a low-gloss ultraviolet curable composition comprises an ultraviolet curable acrylate resin, a photoinitiator, and a flattening agent dispersed within the composition. The ultraviolet curable composition is both thixotropic and shear-thinning and includes less than about 1% by weight volatile organic compounds.

According to a further embodiment, a low-gloss ultraviolet curable composition comprises an ultraviolet curable acrylate resin, a photoinitiator, a flattening agent, and an ionic compound at least partially soluble in the composition. The ionic compound includes a compound that dissociates into a metal cation and an anion, polyatomic ion or polymeric anion,

A method of coating a substrate, such as flooring, is also disclosed. The method includes providing a substrate, roller coating a composition in accordance with exemplary embodiments to a surface of the substrate, and curing the composition by irradiating the snake of the substrate with ultraviolet radiation. In one embodiment, multiple different flattening agents are used in the composition. As a result, when a first location on the substrate surface is irradiated with ultraviolet radiation having an intensity different from that of ultraviolet radiation irradiated upon a second location of the substrate surface, the gloss level of the resultant cured composition at the first and second locations are still substantially uniform.

An advantage of certain embodiments is that incorporating multiple different types of flattening agents, the gloss of the coating lacks sensitivity to ultraviolet intensity, thereby minimizing or eliminating gloss banding across the width of the coated substrate to achieve a substantially uniform gloss.

Another advantage is that certain embodiments are both thixotropic and shear thinning. The thixotropic nature of these embodiments prevents flattening agents and other solid additives, such as texturizers, from settling or otherwise separating from the liquid components of the coating in the absence of continuous agitation. The dual nature of also being shear thinning permits the composition to still be used in roll coating operations.

Still another advantage is that certain embodiments employ an ionic compound. The use of these ionic compounds leads to a composition that exhibits reduced levels of viscosity increase over running time in roller coater applications.

Other features and advantages of the present invention will be apparent from the following more detailed description of exemplary embodiments, which illustrate, by way of example, the principles of the invention.

### BRIEF DESCRIPTION OF THE DRAWINGS

FIG. 1 is a graphical representation of viscosity and shear stress versus different shear rates with respect to Ex. 16.

FIG. 2 is a graphical representation of viscosity and shear stress versus different shear rates with respect to Ex. 20.

FIG. 3 is a graphical representation of viscosity and shear stress versus different shear rates with respect to Ex. 30.

### DETAILED DESCRIPTION

In accordance with exemplary embodiments, ultraviolet curable compositions are provided for use as a protective coating on substrates, such as flooring substrates. The compositions include a ultraviolet curable acrylate resin. Typically a combination of multiple acrylate resins are present in the composition and together make up about 65 to about 95 percent by weight of the composition. Any suitable acrylate resins may be used, although the composition typically includes at least one resin selected from the group consisting of urethane acrylates, polyester acrylates and combinations thereof. Urethane acrylates and polyester acrylates may be commercially obtained or prepared, for example, according to the procedures disclosed in U.S. Pat. Nos, 5,719,227, 5,003,026, and 5,543,232, as well as in U.S. Application Publication No. 2009/0275674, all of which are hereby incorporated by reference in their entireties.

In some cases, it may be desirable to use a bio-based acrylate resin. For example, a biobased urethane acrylate resin can be produced using a vegetable oil based polyol such as castor oil and soya oil based polyols, and/or biobased polyester polyol comprising diacides and/or diols derived from renewable resources such as corn, sugar cane, vegetable oil and the like and/or polyether polyol comprising diols also derived from renewable resources. Examples of biobased components that can be used to make polyester polyols or polyether polyols are sebacic acid, succinic acid, citric acid, azelaic acid, fumaric acid, lactic acid, lactide, 1,3-propanediol, 1,4-butanediol, and glycerol.

Exemplary commercially available acrylate resins that may be used in accordance with exemplary embodiments include EC6360, EC6154B-80, EC61151-80, EC6142H-80, and EC6145-100 all available from Eternal; Actilane 579 and Actilane 505 available from AkzoNobel; Roskydal TP LS 2110, Roskydal UA VP LS 2266. Roskydal VA VP LS 2380, Roskydal UA VP LS 2381 (XD042709), Roskydal UA XP 2416, Desmolux U200, Desmolux U680H, Desmolux XP2491, Desmolux XP2513, Desmolux P175D, Roskydal UA TP LS 2258, Roskydal UA TP LS 2265, and Roskydal UA XP 2430 all available from Bayer; CN965, CN966 A80, CN966 J75, CN981, CN991, CN2920, CN2282, CN985B88, CN2003B, SR 3010, SR 9035, SR833S, SR531, CD420, CD611, SR 351, SR 306, SR395, SR 238, SR399, 2-EHA, SR324, SR257, SR-502, and SR203 all available from Sartomer; Ebecryl 230, Ebecryl 270, Ebecryl 4830, Ebecryl 4833, Ebecryl 4883, Ebecryl 8402, Ebecryl 8405, Ebecryl 8411, Ebecryl 8807, and Ebecryl 809, dipropylene glycol diacrylate (DPGDA), neopentyl glyco propoxylate (2) diacrylate (NPG(PO)2DA), trimethylolpropane ethoxy triacrylate (TMPEOA), isobornyl acrylate (IBOA) Ebecryl 114, and Ebecryl 381 all available from Cytec; and Polyfox 3305, PolyFox 3320, and Polyfox 3510, all available from Omnova. The foregoing acrylates are presented by way of example only and not by way of limitation.

The composition further contains between about 0.5% to about 10% by weight of a photoinitiator, more typically between about I% to about 5% by weight photoinitiator, that is activated by ultraviolet radiation. Any photoinitiator as is known in the art and which is activated by ultraviolet radiation may be used. The photoinitiator is usually, but not necessarily, a free radical photoinitiator. Suitable free radical photoinitiators include unimolecular (Norrish Type I and Type II), bimolecular (Type II), and biomolecular photosensitization (energy transfer and charge transfer). Exemplary classes of free radical photoinitiators that may be employed include, but are not limited to, diphenyl ketone, 1-hydroxycyclohexyl phenyl ketone, phenyl bis (2,4,6-trimethyl benzoyl)phosphine oxide, Esacure KTO-46 (a mixture of phosphine oxide, Esacure KIP150 and Esacure TZT), 2,4,6-trimethylbenzoyldiphenyl phosphine oxide, isopropylthioxanthone, 1-chloro-4-propoxy-thioxanthone, 2,4-diethylthioxanthone, 2-chlorothioxanthone, camphorquinone, 2-ethyl anthranquinone, as well as Irgacure 1700, Irgacure 2020, Irgacure 2959, Irgacure 500, Irgacure 651, Irgacure 754, Irgacure 907 all available front Ciba.

It will be appreciated that in some cases, an amine synergist may be used in combination with the free radical photoinitiators. Examples of amine synergist include, but are not limited to, 2-ethylhexyl-4-dimethylamino benzoate, ethyl 4-(dimethylamine) benzoate, N-methy diethanolamine, 2-dimethylamino ethylbenzoate, and butoxyethyl-4-dimethylamino benzoate, as well as CN371, CN373, CN383, CN384, CN386 all available from Sartomer; Ebecry P104, Ebecry P115, Ebecry 7100 all available from Cytec; and Roskydal UA XP 2299 available from Bayer. The range of the amine synergist is from 0.5% to about 15% by weight in the coating composition, more typically between about 1% to about 5% by weight.

In embodiments in which the resin includes a urethane acrylate and/or polyester acrylate, the ultraviolet curable acrylate resin component also preferably includes a reactive diluent where the coating is to be used in flooring applications. If employed, the reactive diluent is present between about 0.1% to about 90% by weight of the composition, more typically between about 5% to about 70% by weight.

Exemplary acrylate reactive diluents include, but are not limited to, (meth)acrylic acid, isobornyl (meth)acrylate, isodecyl (meth)acrylate, hexanediol di(meth)acrylate, N-vinyl formamide, tetraethylene glycol (meth)acrylate, tripropylene glycol(meth)acrylate, neopentyl glycol di(meth)acrylate, ethoxylated neopentyl glycol di(meth)acrylate, propoxylated neopentyl glycol di(meth)acrylate, trimethylolpropane tri(meth)acrylate, ethoxylated trimethylol propane tri(meth)acrylate, propoxylated trimethylolpropane tri(meth)acrylate, ethoxylated or propoxylated tripropylene glycol di(meth)acrylate, pentaerythritol tri(meth)acrylate, pentaerythritol tetra(meth)acrylate, tris (2-hydroxy ethyl)isocyanurate tri(meth)acrylate and combinations thereof.

Compositions in accordance with exemplary embodiments are low gloss coatings and contain at least one flattening agent, a solid additive dispersed within the composition that has the tendency of reducing the gloss level of the cured composition. According to one embodiment, the composition includes at least three solid additives, at least two of which are different flattening agents. That is, the first flattening agent has at least one property that is different with respect to that of the second flattening agent such that the flattening agents differ by chemistry (i.e., composition), particle size, particle size distribution, surface treatment, surface area amid/or porosity. More than two different flattening agents may be incorporated in the composition and in one embodiment, four or more different flattening agents are used The total amount of flattening agent in the composition is from 1% to about 30% by weight, more typically between about 3% to about 1 5% by weight.

The flattening agents are usually inorganic, typically silica, although organic flattening agents or a combination of inorganic and organic materials may be used as flattening agents. Examples of such flattening agents include but are not limited to, ACEMATT HK125, ACEMATT HK400, ACEMATT HK440, ACEMATT HK450, ACEMATT HK460, ACEMATT OK412, ACEMATT OK 500, ACEMATT OK520, ACEMATT OK607, ACEMATT TS100, ACEMATT 3200, ACEMATT 3300 all available from Evonik; MPP-620XXF, Polyfluo 150, Propylmatte 31 all available from Micropowders; Ceraflour 914, Ceraflour 913 all available from BYK; Gasil ultraviolet70C, Gasil HP280, Gasil HP 860, Gasil HP 870. Gasil IJ 37. Gasil ultraviolet 55C all available from PQ Corporation; Minex 12, Minex 10, Minex 7 and Minex 4 all available from Unimin.

In one embodiment, the acrylate resin ma be provided as a self-matting resin, i.e., already having one or two flattening agents incorporated therein. EC6360 from Eternal is an example of one such suitable material.

In embodiments in which it is desired to impart a texture to the cured coating, such as, for example, to aid in wear resistance or provide traction, a texturizer may be included within the composition as an additional solid additive. The range of the texturizer in the composition is from 1% to about 25% by weight, more typically between about 5% to about 20% by weight. Any fine solid material that can be dispersed within the composition may be used as a texturizer. Depending the coating thickness, the range of mean size of the texturizer particles could be selected from about 10 microns to about 80 microns. Typically, the texturizer is an organic material and in some embodiments is a powder of a polyolefin wax, such as polyethylene or polypropylene. In other embodiment, the texturizer is a powder of polyamide, such as Orgasol 1002 D NAT, Orgasol 2001 EX D NAT, Orgasol 2001 UD NAT 1, Orgasol 2002 D NAT 1, Orgasol 2002 ES 3 NAT, Orgasol 2002 ES 4 NAT, Orgasol 2002 ES 5 NAT, Orgasol 2002 ES 6 Nat 3, Orgasol 3202 D NAT. Orgasol 3502 D NAT all available from Arkema. The use of a texturizer as a solid additive may provide its own matting effect, resulting, in the ability to reduce the number of different flattening agents to two in cases in which a texturizer is also present, so that the total weight percentage of solid additives (i.e., flattening agents and texturizers) in the composition is in the range of from about 2% to about 30% by weight.

It has been determined that the use of multiple different flattening agents alone or in combination with a texturizer so as to have at least three different solid additives present in the composition reduces or eliminates gloss banding that can occur during curing, particularly when the composition is exposed to differing intensities of ultraviolet radiation. As a result, instead of identifiable hands or streaks of varying gloss levels within the flooring or other substrate to which the coating was applied, compositions in accordance with exemplary embodiments result in a substantially uniform gloss level across the entire surface even where two locations of the substrate surface were exposed to different intensities of ultraviolet radiation.

In situations where flattening agents are present in a composition, those solid particles tend to settle out unless the composition is continuously agitated. One manner of reducing the need for agitation is to provide a composition that is thixotropic. That is, the composition has a viscosity that decreases over time under a constant shear rate. In liquids displaying this characteristic, solid additives such as flattening agents and textured particles are prevented from separating. However, in order for the composition to be applied by roll coating operations, a preferred method for applying a curable coating to flooring, the composition should be shear thinning. That is, the composition should exhibit a decreasing viscosity as the shear rate increases.

Surprisingly, it has been determined that compositions can be formed in accordance with exemplary embodiments that exhibit the unusual dual characteristics of being both thixotropic and shear thinning. Thus, the solid additives remain dispersed within the composition in the absence of continuous agitation, even where the compositions have an initial viscosity at room temperature of 1000 cPs or lower. As a result, energy savings can be achieved while still applying the composition according to the preferred method of roller coating. Furthermore, this rheology can be obtained without the use of solvents. Typically, all of the coating compositions described herein contain less than about 1% by weight volatile organic compounds and constitute what those of ordinary skill in the art will appreciate as having a makeup of 100% solids.

In many situations, it is desirable to make large batches of a ultraviolet coating in advance, then supply it to a roll coater for application over several hours or more of manufacturing operations. The viscosity of known ultraviolet coatings tends to increase significantly over time during roll coater application. Thus, as excess coating material is stored and/or recirculated within the roll coater over the course of several hours of manufacturing, the increase in viscosity strains the pump and other fluid handling components which must do more work to overcome the increased resistance to flow.

According to an embodiment, it has been determined that the rate of increase in viscosity previously seen in ultraviolet curable coatings can be significantly moderated by adding one or more ionic compounds to the coating composition. The ionic compound is one that is at least partially soluble in the composition and may consist of metal cations and an anion, polyatomic ion, or polymeric anion. The ionic compounds can include metallic acrylates, metallic diacrylates, metallic acetates, metallic stearates, sodium chloride and calcium chloride, potassium, sodium, calcium, magnesium and zinc salts of polyacrylic acid or acrylic copolymer including branched or hyper-branched acrylic copolymer, all by way of example only.

The inclusion of the ionic compound to the composition results in the viscosity not exhibiting as significant an increase over time and is achieved without the use of solvents. As a result, the coating composition can be stored and used longer before viscosity becomes an impediment to operation, providing for greater efficiencies and less downtime to refresh the roll coater.

Ultraviolet curable coatings in accordance with all of the exemplary embodiments described herein can be applied to any substrate. The substrate can be constructed from a variety of materials, such as wood, ceramic, plastic, or metal, all by way of example. Additionally, the substrate may be, for example, a substrate of a flooring application, such as linoleum, hardwood, laminate, cork, bamboo, ceramic, resilient sheet, or tile.

The flooring substrates to which the coating is applied may be of any size and include sheet goods, which may be in the range of, for example, three feet to eighteen feet wide; engineered wood; solid wood; tile that are cut from such sheet goods; and individually formed tile, typically ranging from one foot square to three foot square, although tiles and other products may also be formed in other shapes, such as rectangles, triangles, hexagons or octagons. In some cases, such as in the case of tiles, engineered wood and solid wood, the flooring substrates may also be in the form of a plank, typically having a width in the range of three inches to twelve inches.

As also previously described, the ultraviolet curable coatings are typically applied as part of a continuous process involving; a roll coater. The coatings are subsequently cured, also as part of the continuous process, under one or more banks of ultraviolet lights or other devices capable of emitting ultraviolet radiation. Because the intensity of those lights may vary where banks overlap as a result of wide widths to be spanned or as a result of other variables, different locations of the substrate may wind up being exposed to different intensities of radiation, that would otherwise result in the gloss banding that the use of exemplary embodiments employing three or more different solid additives overcomes.

### EXAMPLES

The invention is further described by way of the following examples, which are presented by way of illustration, not of limitation.

### Examples 1 Through 17

Examples 1 through 17 were prepared according to the formulations set forth in Tables 1 and 2 and represent low gloss formulations in accordance with exemplary embodiments, in which the amounts shown under each example number are in grams. In each case, the experimental procedure was conducted by first mixing the resin components along with any reactive diluents, amine synergists, surfactants and dispersing agents at room temperature under high speed agitation. Thereafter, the photoinitiator was slowly added with high speed agitation until all initiator was dissolved. The photoinitiator was added at room temperature or, in some cases, at 45 degrees Celsius followed by returning to room temperature. Next, the flattening, i.e. matting, agents were added, except for any flattening agents already present in a self-matting resin. The flattening agents were slowly added to the formulation during high speed agitation, followed by at least an additional 5 minutes of mixing. The formulations were discharged to brown glass jars for storage at room temperature.

TABLE 1

| Tradename | Supplier | Chemical Type | Function | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|---|
| WEA-25 | Armstrong | Polyester acrylate | resin | 17.50 | 21.00 | 16.04 | 21.00 | 25.96 | 0 | 0 | 17.50 | 17.50 |
| EC6360 | Eternal | Polyester acrylate | resin | 17.50 | 21.00 | 25.96 | 21.00 | 16.04 | 35.00 | 35.00 | 17.50 | 17.50 |
| Ebecryl 4883 | Cytec | Urethane acrylate | resin | 15.00 | 0 | 0 | 0 | 0 | 15.00 | 15.00 | 15.00 | 15.00 |
| SR 9035 | Sartomer | Ethoxylated | resin | 9.00 | 14.00 | 14.00 | 14.00 | 14.00 | 9.00 | 9.00 | 9.00 | 9.00 |
| | | Trimethylolpropane | | | | | | | | | | |
| | | Triacrylate | | | | | | | | | | |
| SR833S | Sartomer | Tricyclodecane | resin | 9.00 | 21.00 | 21.00 | 21.00 | 21.00 | 9.00 | 9.00 | 9.00 | 9.00 |
| | | dimethanol | | | | | | | | | | |
| | | diacrylate | | | | | | | | | | |
| SR 351 | Sartomer | Trimethylolpropane | resin | 7.00 | 0 | 0 | 0 | 0 | 7.00 | 7.00 | 7.00 | 7.00 |
| | | Triacrylate | | | | | | | | | | |
| NPG(PO)2DA | Cytec | Neopentyl Glyco | resin | 0 | 14.00 | 14.00 | 14.00 | 14.00 | 0 | 0 | 0 | 0 |
| | | Propoxylate (2) | | | | | | | | | | |
| | | Diacrylate | | | | | | | | | | |
| IBOA | Cytec | Isobornyl Acrylate | resin | 0 | 7.00 | 7.00 | 7.00 | 7.00 | 0 | 0 | 0 | 0 |
| SR 238 | Sartomer | Hexanediol | resin | 20.00 | 0 | 0 | 0 | 0 | 20.00 | 20.00 | 20.00 | 20.00 |
| | | Diacrylate | | | | | | | | | | |
| CN371 | Sartomer | | amine | 2.94 | 3.03 | 3.03 | 3.03 | 3.03 | 2.94 | 2.94 | 2.94 | 2.94 |
| | | | synergist | | | | | | | | | |
| BYK 3530 | BYK | | wetting | 0.79 | 0.81 | 0.81 | 0.81 | 0.81 | 0.79 | 0.79 | 0.79 | 0.79 |
| | Chemie | | agent | | | | | | | | | |
| Benzophenone | Parke- | Diphenyl ketone | initiator | 3.05 | 3.15 | 3.15 | 3.15 | 3.15 | 3.05 | 3.05 | 3.05 | 3.05 |
| | Davis | | | | | | | | | | | |
| Irgacure 184 | Ciba-Geigy | 1-Hydroxy- | initiator | 0.76 | 0.79 | 0.79 | 0.79 | 0.79 | 0.76 | 0.76 | 0.76 | 0.76 |
| | | cyclohexyl phenyl | | | | | | | | | | |
| | | ketone | | | | | | | | | | |
| Gasil | Ineos | Silica | matting | 3.17 | 0 | 3.27 | 3.27 | 4.41 | 1.90 | 1.69 | 3.04 | 2.95 |
| ultraviolet70C | Silicas | | agent | | | | | | | | | |
| Propylmatte | Micro- | polypropylene wax | matting | 0 | 1.64 | 0 | 0 | 0 | 0 | 0 | 0 | 0 |
| 31 | Powder | | agent | | | | | | | | | |
| Acematt 3300 | Degussa | Silica | matting | 1.59 | 3.27 | 1.64 | 1.64 | 2.20 | 0.95 | 0.84 | 1.52 | 1.48 |
| | | | agent | | | | | | | | | |
| Disperbyk | BYK | Acrylic Block- | dispersing | 0.143 | 0.098 | 0.049 | 0.049 | 0.066 | 0.085 | 0.076 | 0.137 | 0.133 |
| 2008 | | copolymer | agent | | | | | | | | | |

TABLE 2

| Tradename | Supplier | Chemical Type | Function | Ex. 10 | Ex. 11 | Ex. 12 | Ex. 13 | Ex. 14 | Ex. 15 | Ex. 16 | Ex. 17 |
|---|---|---|---|---|---|---|---|---|---|---|---|
| WEA-25 | Armstrong | Polyester acrylate | resin | 0 | 0 | 13.37 | 0 | 0 | 31.50 | 0 | 0 |
| EC6360 | Eternal | Polyester acrylate | resin | 35.00 | 35.00 | 21.63 | 35.00 | 35.00 | 10.50 | 35.00 | 35.00 |
| Desmolux | Bayer | Urethane Acrylate | resin | 0 | 0 | 0 | 15.00 | 15.00 | 0 | 15.00 | 15.00 |
| XP2513 | | | | | | | | | | | |
| Ebecryl 8402 | Cytec | Urethane Acrylate | resin | 15.00 | 15.00 | 15.00 | 0 | 0 | 0 | 0 | 0 |
| SR 9035 | Sartomer | Ethoxylated | resin | 9.00 | 9.00 | 9.00 | 0 | 0 | 21.00 | 0 | 0 |
| | | Trimethylolpropane | | | | | | | | | |
| | | Triacrylate | | | | | | | | | |
| SR833S | Sartomer | Tricyclodecane | resin | 9.00 | 9.00 | 9.00 | 20.00 | 20.00 | 14.00 | 20.00 | 20.00 |
| | | dimethanol | | | | | | | | | |
| | | diacrylate | | | | | | | | | |
| SR531 | Sartomer | Cyclic | resin | 0 | 0 | 0 | 9.00 | 9.00 | 0 | 9.00 | 9.00 |
| | | Trimethylolpropane | | | | | | | | | |
| | | Formal Acrylate | | | | | | | | | |
| SR 351 | Sartomer | Trimethylolpropane | resin | 7.00 | 7.00 | 7.00 | 7.00 | 7.00 | 0 | 7.00 | 7.00 |
| | | Triacrylate | | | | | | | | | |
| NPG(PO)2DA | Cytec | Neopentyl Glyco | resin | 0 | 0 | 0 | 0 | 0 | 7.00 | 0 | 0 |
| | | Propoxylate (2) | | | | | | | | | |
| | | Diacrylate | | | | | | | | | |
| TMPEOA | Cytec | Trimethylolpropane | resin | 0 | 0 | 0 | 0 | 0 | 7.00 | 0 | 0 |
| | | Ethoxy Triacrylate | | | | | | | | | |
| Ebecry 114 | Cytec | 2-Phenoxythyl | resin | 0 | 0 | 0 | 9.00 | 9.00 | 0 | 9.00 | 9.00 |
| | | Acrylate | | | | | | | | | |
| SR395 | Sartomer | Isodecryl acrylate | resin | 0 | 0 | 0 | 0 | 0 | 7.00 | 0 | 0 |
| SR 238 | Sartomer | Hexanediol | resin | 20.00 | 20.00 | 20.00 | 0 | 0 | 0 | 0 | 0 |
| | | Diacrylate | | | | | | | | | |
| CN371 | Sartomer | | amine | 2.94 | 2.94 | 2.94 | 2.94 | 2.94 | 3.03 | 2.94 | 2.94 |
| | | | synergist | | | | | | | | |
| BYK 3530 | BYK Chemie | | wetting agent | 0.79 | 0.79 | 0.79 | 0.79 | 0.79 | 0.81 | 0.79 | 0.79 |
| Benzophenone | Parke-Davis | Diphenyl ketone | photoinitiator | 3.05 | 3.05 | 3.05 | 3.05 | 3.05 | 3.15 | 3.05 | 3.05 |
| Irgacure 184 | Ciba-Geigy | 1-Hydroxy | photoinitiator | 0.76 | 0.76 | 0.76 | 0.76 | 0.76 | 0.79 | 0.76 | 0.76 |
| | | cyclohexyl phenyl | | | | | | | | | |
| | | ketone | | | | | | | | | |
| Gasil | Ineos Silicas | Silicas | Matting | 1.90 | 1.69 | 3.17 | 1.96 | 1.88 | 4.41 | 1.88 | 1.88 |
| ultraviolet70C | | | agent | | | | | | | | |
| Propylmatte | MicroPowder | | matting | 0 | 0 | 0 | 0 | 0 | 2.20 | 0 | 0 |
| 31 | | | agent | | | | | | | | |
| Acematt 3300 | Degussa | Silica | matting | 0.95 | 0.84 | 1.59 | 0.98 | 0.94 | 0 | 0.94 | 0.94 |
| | | | agent | | | | | | | | |
| Disperbyk | BYK | Acrylic Block- | Dispersing | 0.0853 | 0.0759 | 0.1427 | 0.0884 | 0.0846 | 0.1322 | 0 | 0 |
| 2008 | | copolymer | agent | | | | | | | | |
| Disperbyk | BYK | | Dispersing | 0 | 0 | 0 | 0 | 0 | 0 | 0.4231 | 0.4231 |
| 185 | | | agent | | | | | | | | |
| SR9016 | Sartomer | Metallic Diacrylate | Additive | 0 | 0 | 0 | 0 | 0 | 00 | 0 | 0.53 |

### Example 18 Through 28

Examples 18 through 28 were prepared according to the formulations set forth in Tables 3 and 4 and represent low gloss formulations in accordance with exemplary embodiments which contain a texturizer, in which the amounts shown under each example number are in grams.

The formulations were prepared in the same way as that of Examples 1 through 17, except that the texturizer was introduced at the point at which the additional matting agents were introduced; in some cases no additional flattening agents were introduced other than those already present in the EC6360.

TABLE 3

| Tradename | Supplier | Chemical Type | Function | Ex. 18 | Ex. 19 | Ex. 20 | Ex. 21 | Ex. 22 |
|---|---|---|---|---|---|---|---|---|
| EC6360 | Eternal | Polyester acrylate | resin | 35.00 | 35.00 | 35.00 | 35.00 | 35.00 |
| Desmolux | Bayer | Urethane Acrylate | resin | 0 | 15.00 | 15.00 | 15.00 | 15.00 |
| XP2513 | | | | | | | | |
| Ebecryl 4883 | Cytec | Urethane Acrylate | resin | 15.00 | 0 | 0 | 0 | 0 |
| SR 9035 | Sartomer | Ethoxylated | resin | 9.00 | 0 | 0 | 0 | 0 |
| | | Trimethylolpropane | | | | | | |
| | | Triacrylate | | | | | | |
| SR833S | Sartomer | Tricyclodecane | resin | 9.00 | 20.00 | 20.00 | 20.00 | 20.00 |
| | | dimethanol | | | | | | |
| | | diacrylate | | | | | | |
| SR531 | Sartomer | Cyclic | resin | 0 | 9.00 | 9.00 | 9.00 | 9.00 |
| | | Trimethylolpropane | | | | | | |
| | | Formal Acrylate | | | | | | |
| SR 351 | Sartomer | Trimethylolpropane | resin | 7.00 | 7.00 | 7.00 | 7.00 | 7.00 |
| | | Triacrylate | | | | | | |
| Ebecryl 114 | Cytec | 2-Phenoxythyl | resin | 0 | 9.00 | 9.00 | 9.00 | 9.00 |
| | | Acrylate | | | | | | |
| SR 238 | Sartomer | Hexanediol | resin | 20.00 | 0 | 0 | 0 | 0 |
| | | Diacrylate | | | | | | |
| CN371 | Sartomer | | amine | 2.94 | 2.94 | 2.94 | 2.94 | 2.94 |
| | | | synergist | | | | | |
| BYK 3530 | BYK | | wetting agent | 0.79 | 0.79 | 0.79 | 0.79 | 0.79 |
| Benzophenone | Park-Davis | Diphenyl ketone | initiator | 3.05 | 3.05 | 3.05 | 3.05 | 3.05 |
| Irgacure 184 | Ciba-Geigy | 1-Hydroxy- | initiator | 0.76 | 0.76 | 0.76 | 0.76 | 0.76 |
| | | cyclohexyl phenyl | | | | | | |
| | | ketone | | | | | | |
| PropylTex | Micropowder | | Textured | 0 | 22.51 | 0 | 0 | 0 |
| 270S | | | Particles | | | | | |
| PropylTex | Micropowder | | Textured | 22.51 | 0 | 22.51 | 22.51 | 22.51 |
| 200SF | | | Particles | | | | | |
| Disperbyk | BYK | | Dispersing | 0 | 0 | 0.502 | 0 | 0 |
| 185 | | | agent | | | | | |
| Solsperse | Lubrizol | | Dispersing | 0 | 0 | 0 | 0.281 | 2.081 |
| 41000 | | | agent | | | | | |

TABLE 4

| Tradename | Supplier | Chemical Type | Function | Ex. 23 | Ex. 24 | Ex. 25 | Ex. 26 | Ex. 27 | Ex. 28 |
|---|---|---|---|---|---|---|---|---|---|
| EC6360 | Eternal | Polyester acrylate | resin | 35.00 | 35.00 | 35.00 | 35.00 | 35.00 | 35.00 |
| Desmolux | Bayer | Urethane Acrylate | resin | 15.00 | 15.00 | 15.00 | 15.00 | 15.00 | 15.00 |
| XP2513 | | | | | | | | | |
| SR833S | Sartomer | Tricyclodecane | resin | 20.00 | 20.00 | 20.00 | 20.00 | 20.00 | 20.00 |
| | | dimethanol | | | | | | | |
| | | diacrylate | | | | | | | |
| SR531 | Sartomer | Cyclic | resin | 9.00 | 9.00 | 9.00 | 9.00 | 9.00 | 9.00 |
| | | Trimethylolpropane | | | | | | | |
| | | Formal Acrylate | | | | | | | |
| SR 351 | Sartomer | Trimethylolpropane | resin | 7.00 | 7.00 | 7.00 | 7.00 | 7.00 | 7.00 |
| | | Triacrylate | | | | | | | |
| Ebecryl 114 | Cytec | 2-Phenoxythyl | resin | 9.00 | 9.00 | 9.00 | 9.00 | 9.00 | 9.00 |
| | | Acrylate | | | | | | | |
| CN371 | Sartomer | | amine | 2.94 | 2.94 | 2.94 | 2.94 | 2.94 | 2.94 |
| | | | synergist | | | | | | |
| BYK 3530 | BYK | | wetting agent | 0.79 | 0.79 | 0.79 | 0.79 | 0.79 | 0.79 |
| Benzophenone | Park-Davis | Diphenyl ketone | initiator | 3.05 | 3.05 | 3.05 | 3.05 | 3.05 | 3.05 |
| Irgacure 184 | Ciba-Geigy | 1-Hydroxy- | initiator | 0.76 | 0.76 | 0.76 | 0.76 | 0.76 | 0.76 |
| | | cyclohexyl phenyl | | | | | | | |
| | | ketone | | | | | | | |
| Gasil | Ineos Silicas | Silica | matting | 0.6253 | 1.8758 | 0 | 0 | 0.6253 | 1.8758 |
| ultraviolet70C | | | agent | | | | | | |
| PropylTex | Micropowder | Polypropylene | textured | 22.51 | 22.51 | 22.51 | 22.51 | 22.51 | 22.51 |
| 200SF | | | Particles | | | | | | |
| Solsperse | Lubrizol | | dispersing | 0.330 | 0.431 | 0 | 0 | 0 | 0 |
| 41000 | | | agent | | | | | | |
| Solsperse | Lubrizol | | dispersing | 0 | 0 | 0.280 | 2.081 | 0.330 | 0.430 |
| 71000 | | | agent | | | | | | |

The formulations of Examples 1 through 5, 7, 10, 12 14, 15, 18 and 19 were subjected to gloss band testing. The samples were coated onto a vinyl floor substrate and then subjected to a two pass cure at a line speed of 55 feet per minute. A first pass was made to obtain a pre-cure using ozone free bulbs in an Aetek ultraviolet curing system with a single lamp at height of 10 inches and a lamp power of 25% with a uliravioletA energy density of 0.130 J/cm² and a peak irradiance of 0.234 W/cm². A final cure was then carried out using a second Aetek ultraviolet curing system having four lamps, this time at a lamp height of 5 inches and a lamp power of 75% with a ultravioletA energy density of 1.021 J/cm² and a peak irradiance of 0.921 W/cm². The substrate temperature was also measured before and after the final cure, with temperature rise measured between 55 and 69° F.

Each of the curing systems used for the first and second passes was to configured to hake an irradiance decline of 30% with an overlap region to achieve a variation in ultraviolet intensity across the width of the substrate being coated.

After curing, 60 degree gloss measurements were taken at each of 17 regularly spaced intervals across the coated substrate. The average gloss measurement and standard deviation were calculated, and the maximum gloss level was noted, as well as the gloss level at the overlap, all of which are reflected in Table 5 along with the substrate/coating temperature before each of the pre-cure and final cure.

The coated substrates were examined to determine whether any gloss banding was visible, particularly within the overlap region. Despite the variations in intensity, none of the sample formulations exhibited any clear gloss banding. As also shown in Table 5 below, the sample formulations exhibited either no banding, or only a minimal amount of banding, that was just barely visible, demonstrating that the samples were not sensitive to ultraviolet intensity and that they exhibited a substantially uniform gloss.

TABLE 5

| | Coating | | | | | | |
|---|---|---|---|---|---|---|---|
| | Temperature | Coating | | | | | |
| | Entry | Temperature | Average | | | | |
| | Precure | Entry Final | Gloss | | | Gloss at | |
| Example | Lamp, F. | Lamp, F. | Reading | St. Dev. | Maximum | Overlap | Banding |
| 1 | 99 | 108 | 26.1 | 1.6 | 27.9 | 21.72 | barely |
| | | | | | | | visible |
| 2 | 101 | 105 | 25.4 | 2.4 | 28.86 | 21.62 | barely |
| | | | | | | | visible |
| 3 | 102 | 109 | 19.6 | 1.8 | 22.8 | 16.74 | barely |
| | | | | | | | visible |
| 4 | 99 | 103 | 26.6 | 1.6 | 29.62 | 24.6 | barely |
| | | | | | | | visible |
| 5 | 87 | 100 | 23.9 | 1.9 | 25.82 | 20.04 | barely |
| | | | | | | | visible |
| 7 | 82 | 96 | 27 | 1.8 | 29.62 | 23.6 | none |
| 10 | 77 | 90 | 22.6 | 1.8 | 24.66 | 18.94 | barely |
| | | | | | | | visible |
| 12 | 80 | 94 | 25.5 | 1.5 | 27.8 | 21.24 | barely |
| | | | | | | | visible |
| 14 | 80 | 93 | 29.9 | 2 | 32.2 | 24.76 | barely |
| | | | | | | | visible |
| 15 | 110 | 112 | 30.1 | 1.4 | 31.94 | 26.58 | none |
| 18 | 74 | 89 | 16.1 | 0.7 | 16.88 | 15.78 | none |
| 19 | 77 | 92 | 15.4 | 0.6 | 16.44 | 14.94 | none |

In addition to gloss banding tests, additional experiments were conducted with additional modifications to the ultraviolet intensity to further confirm that compositions in accordance with exemplary embodiments were not sensitive to variations in ultraviolet intensity. The experimental setup was the same as previously described with respect to the gloss banding test except as otherwise noted below in Tables 6 and 7.

TABLE 6

| | Precure | | | | | | Coating | Coating | Final Cure | |
|---|---|---|---|---|---|---|---|---|---|---|
| | Lamp | Lamp | | | | | Temperature | Temperature | | Lamp |
| | Power, | Height, | J/cm² | W/cm² | J/cm² | W/cm² | Entry | Entry Final | Lamp | Height, |
| Example | % | in | ultraviolet A | ultraviole A | ultraviolet C | ultraviolet C | Precure, F. | Cure, F. | Power, % | in |
| Ex. | 25 | 10 | 0.102 | 0.295 | 0.005 | 0.021 | 73 | 81 | 75/75/75/ | 5 |
| 16 | | | | | | | | | 75 | |
| Ex. | 25 | 10 | 0.102 | 0.295 | 0.005 | 0.021 | 123 | 117 | 75/75/75/ | 5 |
| 16 | | | | | | | | | 75 | |
| Ex. | 25 | 10 | 0.102 | 0.295 | 0.005 | 0.021 | 75 | 85 | 50/50/100/ | 5 |
| 16 | | | | | | | | | 100 | |
| Ex. | 25 | 10 | 0.102 | 0.295 | 0.005 | 0.021 | 120 | 117 | 50/50/100/ | 5 |
| 16 | | | | | | | | | 100 | |
| Ex. | 75 | 10 | 0.211 | 0.371 | 0.011 | 0.018 | 73 | 95 | 50/50/100/ | 5 |
| 16 | | | | | | | | | 100 | |
| Ex. | 25 | 10 | 0.102 | 0.295 | 0.005 | 0.021 | 72 | 81 | 75/75/75/ | 5 |
| 17 | | | | | | | | | 75 | |
| Ex. | 25 | 10 | 0.102 | 0.295 | 0.005 | 0.021 | 125 | 121 | 75/75/75/ | 5 |
| 17 | | | | | | | | | 75 | |
| Ex. | 25 | 10 | 0.102 | 0.295 | 0.005 | 0.021 | 76 | 88 | 50/50/100/ | 5 |
| 17 | | | | | | | | | 100 | |
| Ex. | 25 | 10 | 0.102 | 0.295 | 0.005 | 0.021 | 112 | 115 | 50/50/100/ | 5 |
| 17 | | | | | | | | | 100 | |
| Ex. | — | — | — | — | — | — | — | — | 50/50/100/ | 5 |
| 17 | | | | | | | | | 100 | |
| Ex. | — | — | — | — | — | — | — | — | 25/25/100/ | 5 |
| 17 | | | | | | | | | 100 | |
| Ex. | — | — | — | — | — | — | — | — | 25/25/100/ | 5 |
| 17 | | | | | | | | | 100 | |
| Ex. | 25 | 5 | 0.125 | 0.399 | 0.005 | 0.018 | 121 | 117 | 50/50/100/ | 5 |
| 17 | | | | | | | | | 100 | |
| Ex. | 50 | 5 | 0.188 | 0.706 | 0.009 | 0.031 | 120 | 123 | 50/50/100/ | 5 |
| 17 | | | | | | | | | 100 | |
| Ex. | 75 | 5 | 0.245 | 0.943 | 0.011 | 0.040 | 123 | 120 | 50/50/100/ | 5 |
| 17 | | | | | | | | | 100 | |
| Ex. | 75 | 10 | 0.211 | 0.371 | 0.011 | 0.018 | 120 | 122 | 50/50/100/ | 5 |
| 17 | | | | | | | | | 100 | |
| Ex. | 75 | 10 | 0.211 | 0.371 | 0.011 | 0.018 | 75 | 96 | 50/50/100/ | 5 |
| 17 | | | | | | | | | 100 | |

| | | | | | Coating | Gloss | Gloss |
|---|---|---|---|---|---|---|---|
| | Final Cure | | | | Temperature | 60 deg | 60 deg |
| | J/cm² | W/cm² | | | Exit | (ten | STDEV |
| | ultraviolet | ultraviolet | J/cm² | W/cm² | Final | average | (ten |
| Example | A | A | ultraviolet C | ultraviolet C | Cure, F. | readings) | readings) |
| Ex. | 1.029 | 0.988 | 0.147 | 0.137 | 162 | 35.3 | 5.7 |
| 16 | | | | | | | |
| Ex. | 1.029 | 0.988 | 0.147 | 0.137 | 176 | 16.4 | 2.2 |
| 16 | | | | | | | |
| Ex. | 0.948 | 1.122 | 0.136 | 0.160 | 165 | 33.1 | 3.5 |
| 16 | | | | | | | |
| Ex. | 0.948 | 1.122 | 0.136 | 0.160 | 163 | 15.5 | 1.1 |
| 16 | | | | | | | |
| Ex. | 0.937 | 1.238 | 0.134 | 0.144 | 138 | 26.4 | 3.7 |
| 16 | | | | | | | |
| Ex. | 1.029 | 0.988 | 0.147 | 0.137 | 169 | 54.5 | 3.2 |
| 17 | | | | | | | |
| Ex. | 1.029 | 0.988 | 0.147 | 0.137 | 192 | 22.4 | 3.8 |
| 17 | | | | | | | |
| Ex. | 0.948 | 1.122 | 0.136 | 0.160 | 160 | 49.9 | 2.2 |
| 17 | | | | | | | |
| Ex. | 0.948 | 1.122 | 0.136 | 0.160 | 180 | 31.3 | 2.1 |
| 17 | | | | | | | |
| Ex. | 0.948 | 1.122 | 0.136 | 0.160 | 184 | 31.2 | 2.8 |
| 17 | | | | | | | |
| Ex. | 0.817 | 1.220 | 0.113 | 0.139 | 175 | 25.1 | 2.2 |
| 17 | | | | | | | |
| Ex. | 0.817 | 1.220 | 0.113 | 0.139 | 153 | 56.9 | 1.8 |
| 17 | | | | | | | |
| Ex. | 0.937 | 1.238 | 0.134 | 0.144 | 184 | 22.3 | 2.3 |
| 17 | | | | | | | |
| Ex. | 0.937 | 1.238 | 0.134 | 0.144 | 183 | 23.4 | 2.1 |
| 17 | | | | | | | |
| Ex. | 0.937 | 1.238 | 0.134 | 0.144 | 185 | 20.6 | 2.3 |
| 17 | | | | | | | |
| Ex. | 0.937 | 1.238 | 0.134 | 0.144 | 182 | 25.1 | 1.1 |
| 17 | | | | | | | |
| Ex. | 0.937 | 1.238 | 0.134 | 0.144 | 163 | 49.5 | 2.7 |
| 17 | | | | | | | |

TABLE 7

| | Precure | | | | | | Coating | Coating | Final Cure | |
|---|---|---|---|---|---|---|---|---|---|---|
| | | Lamp | | | | | Temperature | Temperature | Line | |
| | Lamp | Height, | J/cm² | W/cm² | J/cm² | W/cm² | Entry | Entry Final | spd, | |
| Example | Power, % | in | ultraviolet A | ultraviolet A | ultraviolet C | ultraviolet C | Precure, F. | Cure, F. | fpm | Lamp Power, % |
| Ex. 20 | 25 | 10 | 0.102 | 0.318 | 0.005 | 0.013 | 72 | 82 | 53.5 | 75/75/75/75 |
| Ex. 20 | 50 | 10 | 0.159 | 0.345 | 0.008 | 0.016 | 74.5 | 87 | 53.5 | 75/75/75/75 |
| Ex. 20 | 75 | 10 | 0.216 | 0.384 | 0.011 | 0.018 | 74 | 90 | 53.5 | 75/75/75/75 |
| Ex. 20 | 100 | 10 | 0.274 | 0.491 | 0.014 | 0.023 | 75 | 94 | 53.5 | 75/75/75/75 |
| Ex. 20 | 25 | 10 | 0.108 | 0.297 | 0.005 | 0.013 | 77 | 86 | 54 | 50/50/100/100 |
| Ex. 20 | 75 | 10 | 0.216 | 0.439 | 0.012 | 0.019 | 117 | 126 | 55 | 75/75/75/75 |
| Ex. 20 | 75 | 10 | 0.216 | 0.438 | 0.012 | 0.021 | 119 | 125 | 55 | 50/50/100/100 |
| Ex. 20 | 25 | 10 | 0.018 | 0.288 | 0.006 | 0.015 | 123 | 128 | 55 | 50/50/100/100 |
| Ex. 21 | 25 | 10 | 0.108 | 0.297 | 0.005 | 0.013 | 74 | 85 | 54 | 50/50/100/100 |
| Ex. 21 | 75 | 10 | 0.216 | 0.439 | 0.012 | 0.019 | 123 | 124 | 55 | 75/75/75/75 |
| Ex. 23 | 25 | 10 | 0.018 | 0.312 | 0.006 | 0.014 | 75 | 85 | 54 | 50/50/100/100 |
| Ex. 23 | 75 | 10 | 0.216 | 0.439 | 0.012 | 0.019 | 121 | 127 | 55 | 75/75/75/75 |
| Ex. 24 | 25 | 10 | 0.018 | 0.312 | 0.006 | 0.014 | 79 | 88 | 54 | 50/50/100/100 |
| Ex. 24 | 75 | 10 | 0.216 | 0.439 | 0.012 | 0.019 | 125 | 130 | 55 | 75/75/75/75 |
| Ex. 25 | 25 | 10 | 0.108 | 0.297 | 0.005 | 0.013 | 108 | 107 | 54 | 50/50/100/100 |
| Ex. 25 | 25 | 10 | 0.108 | 0.297 | 0.005 | 0.013 | 76 | 85 | 54 | 50/50/100/100 |
| Ex. 25 | 75 | 10 | 0.216 | 0.439 | 0.012 | 0.019 | 123 | 130 | 55 | 75/75/75/75 |
| Ex. 27 | 25 | 10 | 0.018 | 0.312 | 0.006 | 0.014 | 75 | 86 | 54 | 50/50/100/100 |
| Ex. 27 | 75 | 10 | 0.216 | 0.439 | 0.012 | 0.019 | 125 | 134 | 55 | 75/75/75/75 |
| Ex. 28 | 75 | 10 | 0.216 | 0.439 | 0.012 | 0.019 | 124 | 134 | 55 | 75/75/75/75 |
| Ex. 28 | 25 | 10 | 0.018 | 0.312 | 0.006 | 0.014 | 79 | 88 | 54 | 50/50/100/100 |

| | | | |
|---|---|---|---|
| | Coatings | Gloss | Gloss |
| Final Cure | Temperature | 60 deg | 60 deg |

| | J/cm² | W/cm² | | | Exit | (ten | STDEV |
|---|---|---|---|---|---|---|---|
| | ultraviolet | ultraviolet | J/cm² | W/cm² | Final | average | (ten |
| Example | A | A | ultraviolet C | ultraviolet C | Cure, F. | readings) | readings) |
| Ex. 20 | 1.069 | 1.086 | 0.155 | 0.148 | 152 | 11.3 | 0.5 |
| Ex. 20 | 1.069 | 1.086 | 0.155 | 0.148 | 152 | 10.0 | 0.6 |
| Ex. 20 | 1.069 | 1.086 | 0.155 | 0.148 | 148 | 11.7 | 1.0 |
| Ex. 20 | 1.069 | 0.086 | 0.155 | 0.148 | 151 | 11.7 | 0.4 |
| Ex. 20 | 1.069 | 1.354 | 0.151 | 0.159 | 153 | 10.6 | 0.6 |
| Ex. 20 | 1.069 | 1.087 | 0.153 | 0.147 | 153 | 8.9 | 0.6 |
| Ex. 20 | 1.040 | 1.211 | 0.150 | 0.169 | 187 | 6.5 | 0.3 |
| Ex. 20 | 1.046 | 1.256 | 0.151 | 0.163 | 185 | 7.1 | 0.6 |
| Ex. 21 | 1.069 | 1.354 | 0.151 | 0.159 | 147 | 11.0 | 0.6 |
| Ex. 21 | 1.069 | 1.087 | 0.153 | 0.147 | 152 | 8.0 | 0.4 |
| Ex. 23 | 1.057 | 1.354 | 0.151 | 0.156 | 152 | 10.9 | 1.2 |
| Ex. 23 | 1.069 | 1.087 | 0.153 | 0.147 | 187 | 6.7 | 0.4 |
| Ex. 24 | 1.057 | 1.354 | 0.151 | 0.156 | 166 | 10.0 | 0.4 |
| Ex. 24 | 1.069 | 1.087 | 0.153 | 0.147 | 189 | 6.9 | 0.3 |
| Ex. 25 | 1.069 | 1.354 | 0.151 | 0.159 | 166 | 8.9 | 0.9 |
| Ex. 25 | 1.069 | 1.354 | 0.151 | 0.159 | 152 | 10.4 | 0.5 |
| Ex. 25 | 1.069 | 1.087 | 0.153 | 0.147 | 187 | 6.6 | 0.6 |
| Ex. 27 | 1.057 | 1.354 | 0.151 | 0.156 | 152 | 9.2 | 0.5 |
| Ex. 27 | 1.069 | 1.087 | 0.153 | 0.147 | 189 | 6.0 | 0.2 |
| Ex. 28 | 1.069 | 1.087 | 0.153 | 0.147 | 186 | 5.5 | 0.2 |
| Ex. 28 | 1.057 | 1.354 | 0.151 | 0.156 | 155 | 9.3 | 0.7 |

### Example 29 Through 33

Examples 29 through 33 were prepared according to the formulations set forth in Table 8 to which an ionic compound was added to the formulations identified as Examples 16 and 20 above; the amounts shown under each example number are in grams. These additional examples were prepared by adding the ionic compound to the already formulated ultraviolet curable composition.

TABLE 8

| Compound | Supplier | Ex. 29 | Ex. 30 | Ex. 31 | Ex. 32 | Ex. 33 |
|---|---|---|---|---|---|---|
| Ex. 16 | | 7400.0 | 0 | 0 | 0 | 0 |
| Ex. 20 | | 0 | 100.00 | 100.00 | 100.00 | 100.00 |
| SR9016 | Sartomer | 37.19 | 1.01 | 0 | 0 | 0 |
| (Metallic | | | | | | |
| diacrylate) | | | | | | |
| Zincum 5 | Baerlocher | 0 | 0 | 1.01 | 0 | 0 |
| (Zinc salt of | Linger | | | | | |
| C16-C18 | | | | | | |
| fatty acid) | | | | | | |
| Zinc Acetate | Aldrich | 0 | 0 | 0 | 1.01 | 0.50 |

The initial viscosity of each of Examples 29 through 13, as well as that of Example 17 (which contained an ionic compound as formulated), was measured over time during a roll coater application and compared to that of the base formulation from which they were formed (i.e, Examples 16 and 20) and which did not contain the ionic compound. All measurements were taken at room temperature and were conducted hourly. Measurements of the compositions not containing a texturizer Examples 16, 17 and 28) were obtained using a Brookfield viscometer at 20 RPM with a number 5 spindle, while measurements of compositions containing a texturizer (i.e., Examples 20 and 30-33) were obtained using a Brookfield viscometer at 100 RPM with a number 6 spindle. All results are shown below in Table 9.

Despite some fluctuations that merely represent difficulties in obtaining consistent, precise viscosity measurements of fluids having a viscosity less than 1000 cPs, the results of the experiments clearly demonstrated that although the formulations without the ionic additive exhibit a steady increase in viscosity over time in the roller application, those containing the ionic compound generally exhibited both a lower viscosity and that the viscosity increased at a slower rate over time in the roll coater application.

TABLE 9

| | Viscosity at | Viscosity at | Viscosity at | Viscosity at | Viscosity at | Viscosity at | Viscosity at | Viscosity at |
|---|---|---|---|---|---|---|---|---|
| | Hour 0 | Hour 1 | Hour 2 | Hour 3 | Hour 4 | Hour 5 | Hour 6 | Hour 7 |
| | (cPs) | (cPs) | (cPs) | (cPs) | (cPs) | (cPs) | (cPs) | (cPs) |
| Ex. 16 | 1340 | 2060 | 2320 | 2800 | 2840 | 3340 | 4060 | 4120 |
| Ex. 17 | 820 | 960 | 980 | 1080 | 1140 | 1400 | 1440 | 1370 |
| Ex. 29 | 820 | 960 | 980 | 1080 | 1140 | 1400 | 1440 | 1370 |
| Ex. 20 | 650 | 800 | 950 | 950 | 1050 | 1100 | 1125 | 1100 |
| Ex. 30 | 850 | 600 | 500 | 850 | 500 | 750 | 650 | 600 |
| Ex. 31 | 500 | 450 | 600 | 700 | 600 | 500 | 650 | 650 |
| Ex. 32 | 550 | 875 | 800 | 450 | 500 | 300 | 600 | 500 |
| Ex. 33 | 550 | 350 | 750 | 750 | 600 | 850 | 850 | 750 |

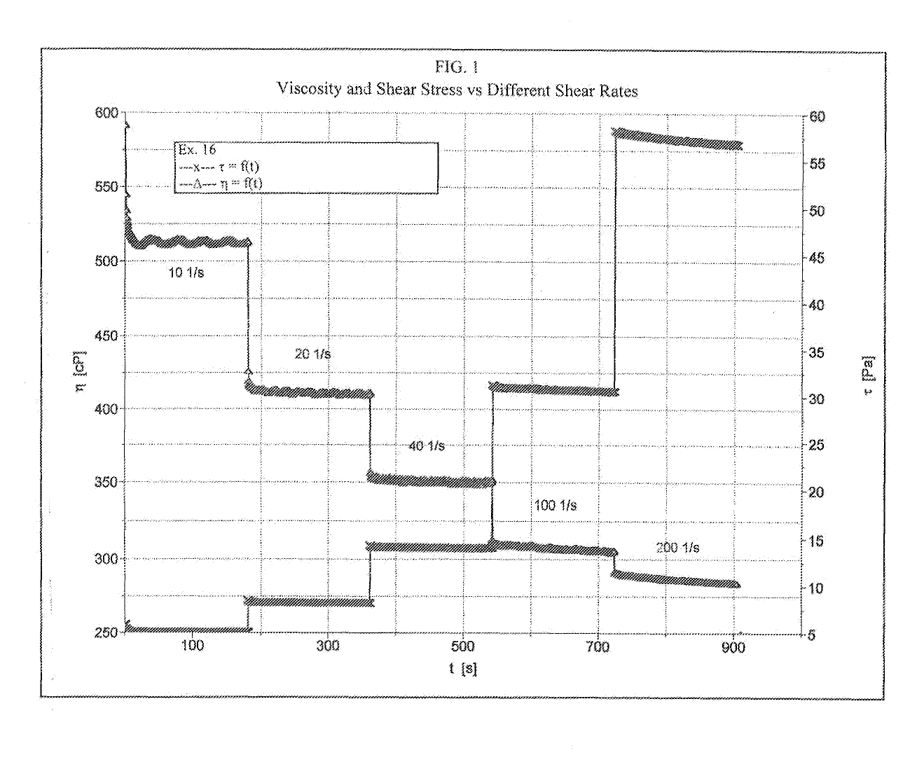

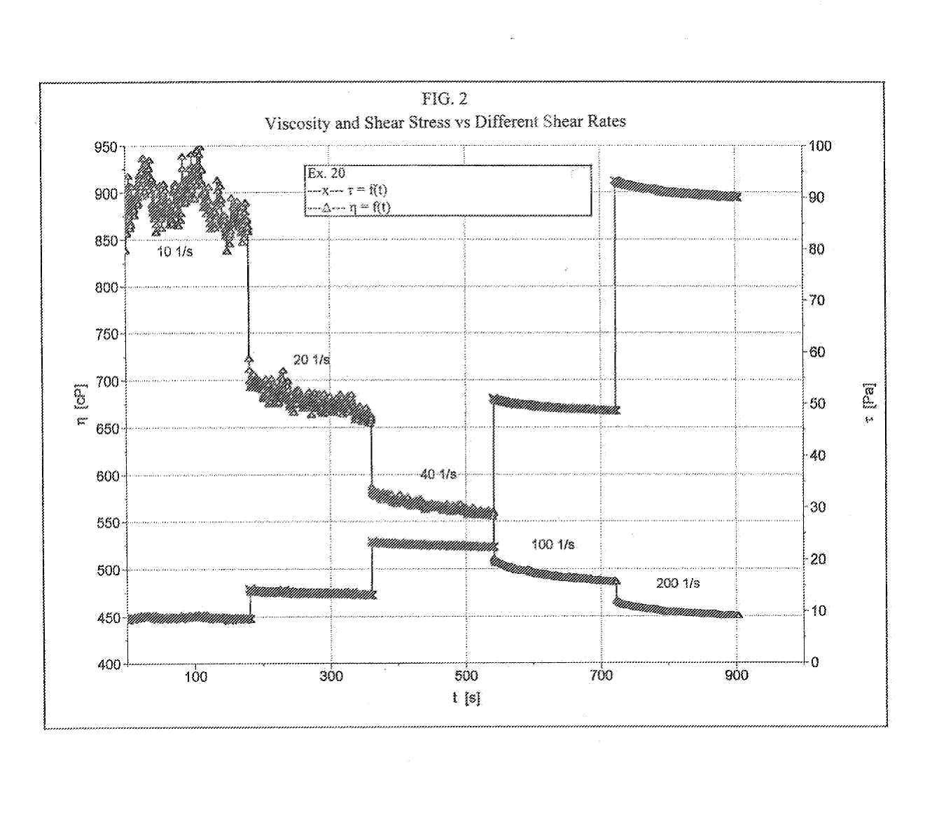

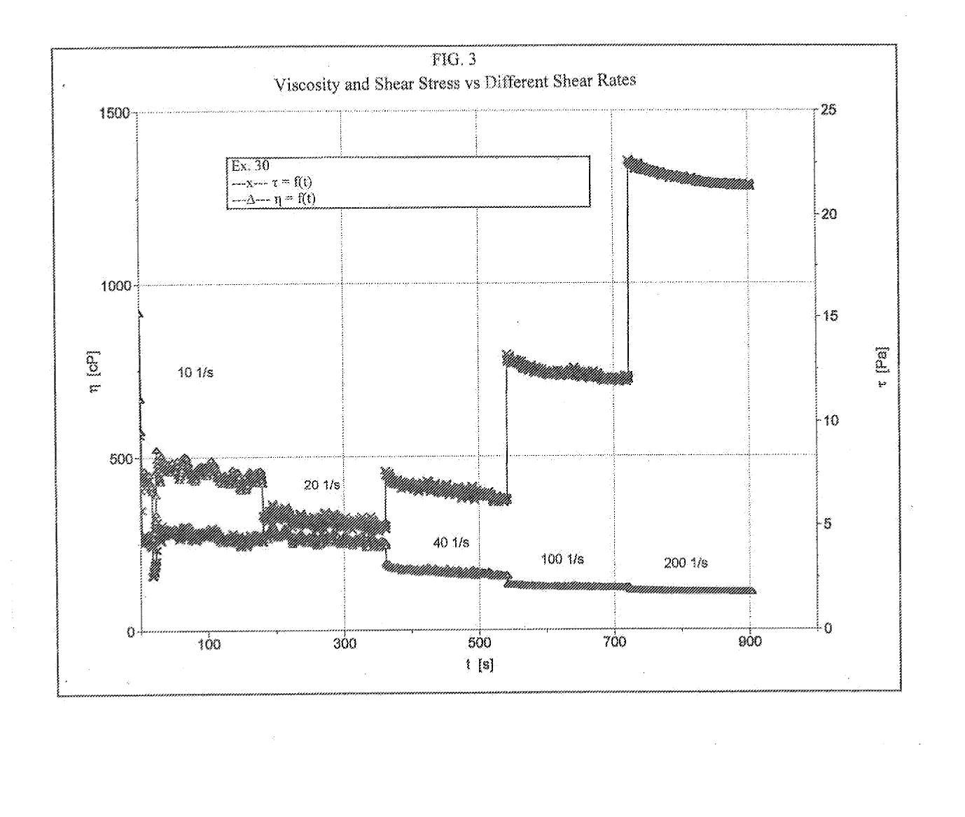

Rheology tests were also performed on various sample formulations to measure viscosity versus changing shear rate and viscosity over time at a constant shear rate. Data generated from those measurements for Examples 16. 20 and 30 are illustrated in FIGS. 1 through 3. These Figures illustrate that the compositions exhibit a dual nature of being both thixotropic and shear thinning. As the shear rate is increased over time in a stepwise fashion, the viscosity decreases consistent with a shear thinning fluid. However, as also illustrated, when the shear rate is maintained substantially constant at each step, the formulations still exhibit a measureable decrease in viscosity, consistent with a thixotropic fluid.

The foregoing, illustrates some of the possibilities for practicing the invention. Many other embodiments are possible within the scope and spirit of the invention. It is, therefore, intended that the foregoing description he regarded as illustrative rather than limiting, and that the scope of the invention is given by the appended claims together with their full range of equivalents.

1. A low-gloss ultraviolet curable composition comprising:
an ultraviolet curable acrylate resin;
a photoinitiator; and
at least three different solid additives dispersed within the ultraviolet curable composition, at least two of the solid additives being flattening agents, wherein the first flattening agent has a property that is different with respect to that of the second flattening agent.

2. The composition of claim 1, comprising at least four different flattening agents.

3. The composition of claim 1, wherein the flattening agents comprise silica.

4. The composition of claim 1, wherein the third solid additive is a texturizer.

5. The composition of claim 1, further comprising an additive selected, from the group consisting of a surfactant, a reactive diluent, an amine synergist and combinations thereof.

6. The composition of claim 1, further comprising an ionic compound that is at least partially soluble in the composition.

7. The composition of claim 7, wherein the ionic compound is a metallic acrylate, a metallic diacrylate, a metallic acetate, a metallic stearate, or a combination thereof.

8. The composition of claim 7, wherein the ionic compound is a salt selected from the group consisting of sodium chloride; calcium chloride; potassium, sodium, calcium, magnesium and zinc salts of polyacrylic acid; and potassium, sodium, calcium, magnesium and zinc salts of acrylic copolymer including branched or hyper-branched acrylic copolymer.

9. The composition of claim 1, wherein the acrylate resin comprises a resin selected from the group consisting of polyester acrylate resins, urethane acrylate resins, and combinations thereof.

10. The composition of claim 1, wherein the acrylate resin comprises a self-flattening acrylate composition.

11. The composition of claim 1, wherein the composition includes less than 1% by weight volatile organic compounds.

12. The composition of claim 1, wherein the property that is different is selected from chemistry, particle size, particle size distribution, surface treatment, surface area and porosity.

13. A low-gloss ultraviolet curable composition comprising:
an ultraviolet curable acrylate resin;
a photoinitiator;
a flattening agent; and
an ionic compound at least partially soluble in the composition.

14. The composition of claim 13, wherein the composition is both thixotropic and shear thinning.

15. The composition of claim 13, wherein the composition includes less than about 1% by weight volatile organic compounds.

16. The composition of claim 13, wherein the composition includes less than 1% by weight volatile organic compounds.

17. A method of coating a substrate comprising:
providing a substrate;
roller coating the low-gloss ultraviolet curable composition of claim 1 to a surface of the substrate: and
curing the composition by irradiating the surface of the substrate with ultraviolet radiation, wherein a first location on the substrate surface is irradiated with ultraviolet radiation having an intensity different from that of ultraviolet radiation irradiated upon a second location of the substrate surface, wherein a gloss level of the cured composition at the first and second locations of the substrate surface are substantially uniform.

18. The method of claim 17, wherein the step of providing a substrate comprises providing flooring and wherein the step of roller coating comprises applying the composition as a wear coating to the top surface of the flooring.

19. The method of claim 17, wherein the composition to be roller coated is stored in the absence of continuous agitation prior to roller coating.

20. The method of claim 17, wherein the step of roller coating includes roller coating the composition having less than about 1% by weight volatile organic compounds.
